(19) United States
(12) Patent Application Publication
(10) Pub. No.: US 2017/0269697 A1
(43) Pub. Date: Sep. 21, 2017

(54) UNDER-WRIST MOUNTED GESTURING

(71) Applicant: Intel Corporation, Santa Clara, CA (US)

(72) Inventors: Robert L. Vaughn, Portland, OR (US); Aziz M. Safa, Phoenix, AZ (US); Vishwa Hassan, Chandler, AZ (US)

(21) Appl. No.: 15/075,961

(22) Filed: Mar. 21, 2016

(51) Int. Cl. G06F 3/01; G06F 3/0488; G06F 3/0482; G06F 1/16; H04M 1/725

(52) U.S. Cl. CPC G06F 3/017; G06F 1/163; H04M 1/72527; H04M 1/7253; G06F 3/016; G06F 3/0482; G06F 3/0488; G06F 2203/04808

(57) ABSTRACT

The present disclosure describes a number of embodiments related to devices, systems, and methods for receiving from one or more under-wrist sensors data on finger movements of the user, identifying the location and/or movement respectively of one or more fingers of the user, determining an indication of one or more commands based at least on the identified location and/or movement respectively of one or more fingers of the user, and transmitting the indication of the one or more commands to a device, such as a smartwatch, associated with the user.

### FIELD

Embodiments of the present disclosure generally relate to the field of computing. More specifically, embodiments of the present disclosure relate to devices and methods for sensing wrist movements and finger positions used to interact with a mobile computing device (hereinafter, simply mobile device).

### BACKGROUND

Over the last decade, mobile devices, and in particular wearable mobile devices, have become increasingly popular. On example is a smartwatch that may be worn like a traditional wristwatch on one hand, and has an electronic display to provide a customized information experience for the user. The user may interact with the smartwatch in a variety of ways. The smartwatch may request input from the user, for example by prompting the user by displaying menu selections, icon choices, or text to which the user may respond. In legacy implementations, the user might respond by touching the face of the smartwatch in response to the prompts, using a finger or a stylus. This interaction may be difficult for a number of reasons, including the small display size for a touchscreen, the difficulty of carrying around a stylus to interact with the touchscreen, and the imprecision of using a finger as a stylus. In addition, wearing a smartwatch on one wrist, for example the left wrist, typically requires using the fingers on the other hand to interact with the smartwatch. Both hands are typically used to interact with the smartwatch.

### BRIEF DESCRIPTION OF THE DRAWINGS

Some of these difficulties may be remediated through embodiments in which a sensor associated with a mobile device, such as a smartwatch, is mounted so that the sensor may detect the position and/or movement of one or more fingers of one of the user's hand, e.g., the hand on which the smartwatch is worn. The one or more fingers need not be in contact with the mobile device. In embodiments, the sensor may be located on the bottom of the wrist and attached to the same band used to secure the mobile device to the top of the wrist. In embodiments, finger position and/or movements may be translated into cursor motion and function selection on the mobile device. This process and/or apparatus may be used for controlling many mobile devices, including smart phones, such as specialized devices to control equipment, in-vehicle gesturing, or one-handed control of other systems, devices, and/or user interfaces. In embodiments, a smartwatch, classical style watch, or bracelet, may be worn on the top of the wrist, or may be worn on the bottom of the wrist.

In embodiments, the user may provide gesture input to a mobile device, such as a smartwatch, from the same hand onto which the watch is attached (without contacting the mobile device), and the user's other hand may remain free for other activities, or none.

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a diagram of components in an under-wrist mounted gesturing device, in accordance with some embodiments.

FIG. 2 illustrates a perspective view of an under-wrist mounted gesturing device in use, in accordance with some embodiments.

FIGS. 3A-3B illustrates a perspective view of an under-wrist mounted gesturing device in use, and a top view of an associated face of a smartwatch, in accordance with some embodiments.

FIGS. 4A-4B illustrates a perspective view of an under-wrist mounted gesturing device in use with two fingers, and a top view of an associated face of a smartwatch, in accordance with some embodiments.

FIGS. 5A-5B illustrates a perspective view of an under-wrist mounted gesturing device in use with four fingers, and a top view of an associated face of a smartwatch, in accordance with some embodiments.

FIGS. 6A-6B illustrates a perspective view of the interaction of an under-wrist mounted gesturing device detecting finger movement to provide input to a smartwatch, and a top view of an associated face of the smartwatch, in accordance with some embodiments.

FIGS. 7A-7B illustrate example behaviors of individuals viewing a smartwatch device, in accordance with some embodiments.

FIGS. 8A-8D illustrate multiple perspective views of determining an extension and/or contraction range of a pointer finger using an under-wrist mounted gesturing device, in accordance with some embodiments.

FIG. 9 is a block diagram illustrates a method for implementing an under-wrist mounted gesturing device, in accordance with some embodiments.

FIG. 10 is a diagram 1000 illustrating computer readable media 1002 having instructions for practicing under-wrist mounted gesturing, in accordance with some embodiments.

### DETAILED DESCRIPTION

Methods, apparatuses, and systems for an under-wrist apparatus to determine hand gestures of a user, that may allow the user to interact with a mobile device, such as a smartwatch, without contacting the mobile device, are disclosed herein.

In embodiments, under-wrist apparatus may include one or more sensors to be attached to the underside of a wrist of a user to collect sensor data on finger movements or wrist movements of the user (e.g., fingers of the hand on which an under-wrist sensor is worn). Embodiments may further include circuitry proximally disposed at the underside of the wrist of the user and coupled to the one or more sensors to process the sensor data to identify a location and/or movement of a finger of the user e.g., fingers of the hand the one or more sensors are attached), determine an indication of one or more commands based at least on the identified location and/or movement of the finger, and/or transmit or cause to transmit the indication of the one or more commands to a device associated with the user (e.g., a device worn on the same hand). Details of these and/or other embodiments, as well as some advantages and benefits, are disclosed and described herein.

In the following description, various aspects of the illustrative implementations are described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “including,” “having,” and the like, as used with respect to embodiments of the present disclosure, are synonymous.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

Various operations are described as multiple discrete operations in turn, in a manner that is most helpful in understanding the claimed subject matter. However, the order of description should not be construed as to imply that these operations are necessarily order dependent.

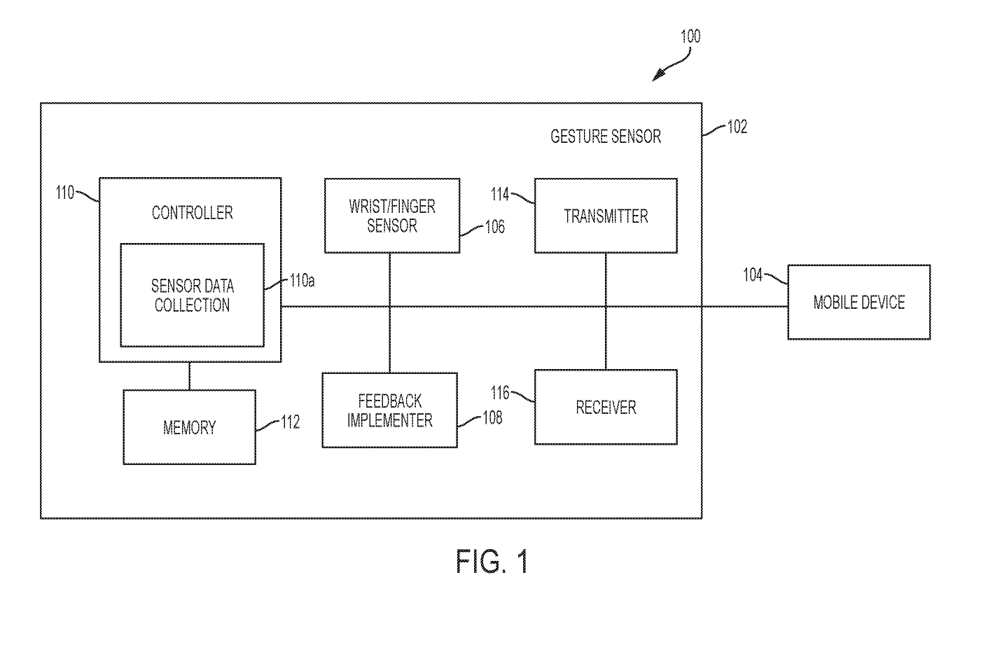

FIG. 1 is a diagram of components in an under-wrist mounted gesturing device, in accordance with some embodiments. Diagram 100 shows a gesture sensor 102 that may be coupled with an associated mobile device 104. In embodiments, the gesture sensor 102 and the mobile device 104 may be included within the same device, or may be separate devices that are coupled using a wireless or wired communication link.

In embodiments, the gesture sensor 102 may include a transmitter 114 or a receiver 116 used to send and/or receive signals to the mobile device 104, or any other device with which the gesture sensor 102 may communicate. The transmitter 114 or receiver 116 may transmit or receive signals using a direct connection, for example a universal serial bus (USB) connection, a wireless connection, for example Wi-Fi or Bluetooth®, or any other appropriate connection. In embodiments, the mobile device 104 may be able to receive or transmit signals from or to the gesture sensor 102. In embodiments, sending signals by the gesture sensor 102 to the mobile device 104 may facilitate data input or other indications to an application that may be running on the mobile device 104. In a non-limiting example, detected finger movements may be translated into graphical user interface (GUI) cursor movements, selections, or other functions corresponding to a display of the mobile device 104.

In embodiments, receiving signals by the gesture sensor 102 from the mobile device 104 may facilitate adjustments to the gesture sensor 102 or may implement feedback, for example haptic feedback, to a user wearing the gesture sensor 102.

The gesture sensor 102 may include a wrist/finger sensor 106 that may be used to indicate the location and/or movement of one or more fingers and/or the movement and/or position of a wrist of the user wearing the gesture sensor 102. In embodiments, the wrist/finger sensor 106 may use a number of sensing technologies including but not limited to infrared sensing, acoustic sensing, laser sensing, depth-sensing cameras, or stereoscopic sensing. In embodiments, the wrist sensor 106 may also use sensing technologies including an accelerometer, compass, or camera. The wrist/finger sensor 106 may use these technologies to identify a location of one or more fingers, to identify the movement of one or more fingers, or to identify the movement of the wrist of a user wearing the gesture sensor 102.

In embodiments, the wrist/finger sensor 106 may detect movement of one or more fingers by using a beam emitter and detector that may be mounted to the bottom of the user's wrist. In embodiments, the wrist/finger sensor 106 may detect movements of the user's wrist by an accelerometer or other suitable device. In embodiments, the emitter and detector may be mounted through an attachment to a wristband, bracelet, wristwatch, smartwatch, or any other suitable wrist attachment. In addition, Intel® RealSense™ systems may be used to implement some or all of the functions of the wrist/finger sensor 106.

In embodiments, the gesture sensor 102 may identify a movement of the wrist of the user as a command to be sent to the mobile device 104. For example, identifying when a user lifts or turns a wrist in a particular way may indicate a command to the mobile device 104 to turn on and display a particular screen to the user, or to implement some other function. Movements may include the wrist moving up or down, side to side, rotationally, or any combination. In embodiments where the mobile device 104 is a smartwatch or similar device, the detection of a particular rotation of the wrist may be a frequent indicator of a command, for example to turn the smartwatch on and display information.

In embodiments, the feedback implementer 108 may provide feedback information to the user wearing the gesture sensor 102. In embodiments, this feedback may come in the form of haptic feedback, which may include vibrations or pulsing of different durations and frequencies based at least on wrist or finger locations or movement. For example, if a user wearing the device makes a gesture corresponding to entering a command to a mobile device 104, the gesture sensor 102 may receive a command to provide feedback in the form of a buzzer or a pulse to the user's wrist to indicate that the command has been successfully completed. In embodiments, the feedback may also be auditory.

In embodiments, the gesture sensor 102 may also include additional inputs, for example a manual on/off switch (not shown), a sensitivity indicator input that may adjust the sensitivity of the motion and/or location of the wrist/finger sensor 106 (not shown), or an adjustment input that may be to adjust the level of the haptic feedback or to enable and disable haptic feedback. In embodiments, the gesture sensor 102 may include a controller 110, that may include circuitry to process the information received from other devices, and a sensor data collection 110a that may provide storage for historical sensor data or for other data that may be used by the controller 110. Memory 112 may include volatile or non-volatile storage used by the controller 110, including machine instructions and/or data used by a processor that may be within the controller 110.

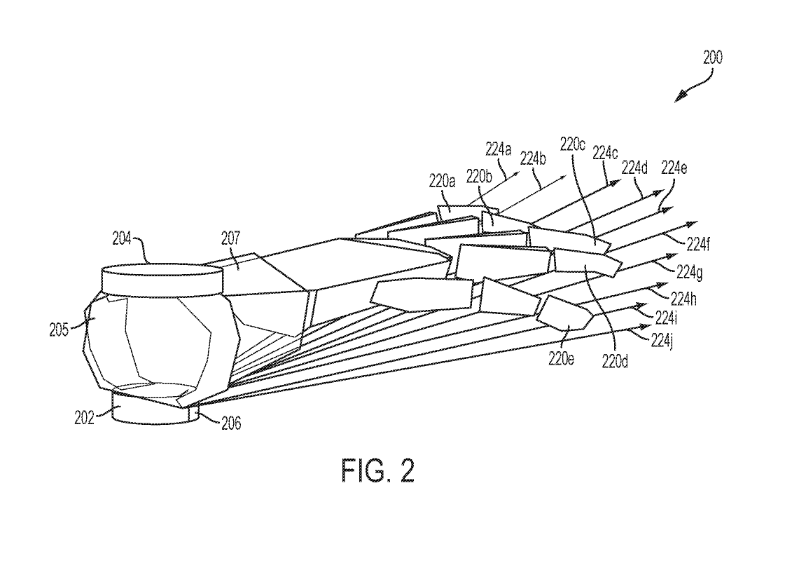

FIG. 2 illustrates a perspective view of an under-wrist mounted gesturing device, in accordance with some embodiments. Diagram 200 shows an illustration of an embodiment used with a left hand, with the palm facing downward. A gesture sensor 202, which may be similar to the gesture sensor 102 shown in FIG. 1, is attached to a wrist 207 by a band 205. A mobile device 204, which may be similar to the mobile device 104 of FIG. 1, may be also attached by band 205. In embodiments, the mobile device 204 may be a smartwatch. In embodiments, positioning the gesture sensor 202 on the underside of the wrist 207 may provide a preferred way to sense the location and/or movement of wrist 207 or of fingers 220a-220e by providing a better field of view for sensing fingers 220a-220e. For ease of description, a thumb may be described as a finger, for example finger 220e. However, the illustrated position is not to be read as limiting on the present disclosure. In alternate embodiments, gesture sensor 202 may be disposed at other locations of the hand to which mobile device 204 is attached, or even on the other hand.

In embodiments, a wrist/finger sensor 206, which may be similar to the wrist/finger sensor 106 of FIG. 1, may emit beams 224a-224j from the underside of the wrist 207. In embodiments, positioning the wrist/finger sensor 206 under the wrist may provide a better field of view for those technologies used to detect finger location and/or movement. In embodiments, the wrist/finger sensor 206 may detect those emitted beams 224a-224j and determine, based upon the detection, location of or movement of fingers 220a-220e. In embodiments, the beams may be discrete beams or scanned beams. In embodiments, the beams may be laser light. In embodiments, an accelerometer (not shown) may be contained within gesture sensor 202 to identify movements and/or rotations of the wrist 207. Embodiments, depending upon the sensing technology used, may operate while the sensing path between the wrist/finger sensor 206 and an individual finger is not blocked. In embodiments, the sensitivity of the wrist/finger sensor 206 may be adjusted.

Sensing technologies for object movement detection may include those facilitated by reflection of radio, laser, or sound energy. In embodiments, reflection may be used either in a scanning manner or from discrete beams. Additionally, camera systems such as Intel's RealSense may be used, as well as any suitable technology that may determine finger location or movement.

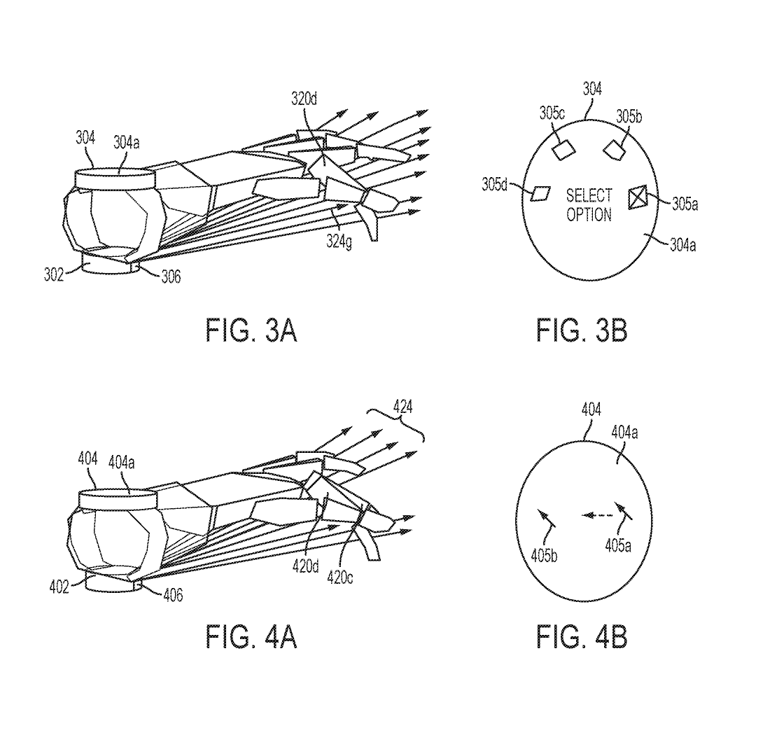

FIGS. 3A-6B illustrate a perspective views of the interaction of an under-wrist mounted gesturing device detecting various finger positions and movements to facilitate interactions with a remote device, for example a smartwatch, in accordance with some embodiments.

FIG. 3A illustrates a perspective view of an embodiment used on a left hand, with the palm facing down. FIG. 3A shows a finger 320d, which may be similar to finger 220d of FIG. 2, that is in a lowered position, blocking beam 324g, which may be similar to beam 224g of FIG. 2. In embodiments, the wrist/finger sensor 306, which may be similar to wrist/finger sensor 106 of FIG. 1, may detect the reflection of beam 324g.

FIG. 3B illustrates the face of a smartwatch 304, which may be similar to mobile device 104 of FIG. 1, having a display face 304a, in some embodiments. The smartwatch 304 may be running an application displaying a query on the smartwatch display face 304a, that requests the user wearing the smartwatch 304 make a selection of one of four options 305a-305d. In this example, one of the 5 fingers, when moved, may implement a respective function that may be associated with respective menu selection buttons 305a-305d on the display 304a.

By moving finger 320d down, the application on the smartwatch 304 may receive input from the gesture sensor 302, which may be similar to the gesture sensor 102 of FIG. 1, and interprets the gesture as a command to select the button 305a on the display 304a that corresponds to the index finger 320d. The command may be, for example, check temperature of display a lower-level hierarchical menu.

In embodiments, if the mobile device 304 is a device in a car, various hand gestures may be used to operate various functions within the car. For example, when the driver's right palm is up, it may indicate request for assistance. In embodiments the gesture sensor 302 may be used to provide a means of navigating through menu selections on blue tooth headsets, in-vehicle entertainment/control systems, or other mobile devices.

FIG. 4A illustrates a perspective view of an embodiment used on a left hand, with the palm facing down. FIG. 4A shows an index finger 420d, which may be similar to finger 220d of FIG. 2, and a middle finger 420c, which may be similar to finger 220c of FIG. 2, that are in a lowered position. In this position, some of beams 424, which may be similar to some of beams 224 of FIG. 2, may be blocked and the wrist/finger sensor 406, which may be similar to wrist/finger sensor 106 of FIG. 1, may detect the reflection of the blocked beams.

FIG. 4B illustrates the face of a smartwatch 404, which may be similar to mobile device 104 of FIG. 1, having a display face 404a. The smartwatch 404 may be running an application displaying a cursor 405a on a smartwatch display face 404a. The user may wish to move the cursor to the position 405b. In this example, the two fingers, when moved, may send an indication of one or more commands to the smartwatch 404 to move the cursor from a first position 405a to a second position 405b.

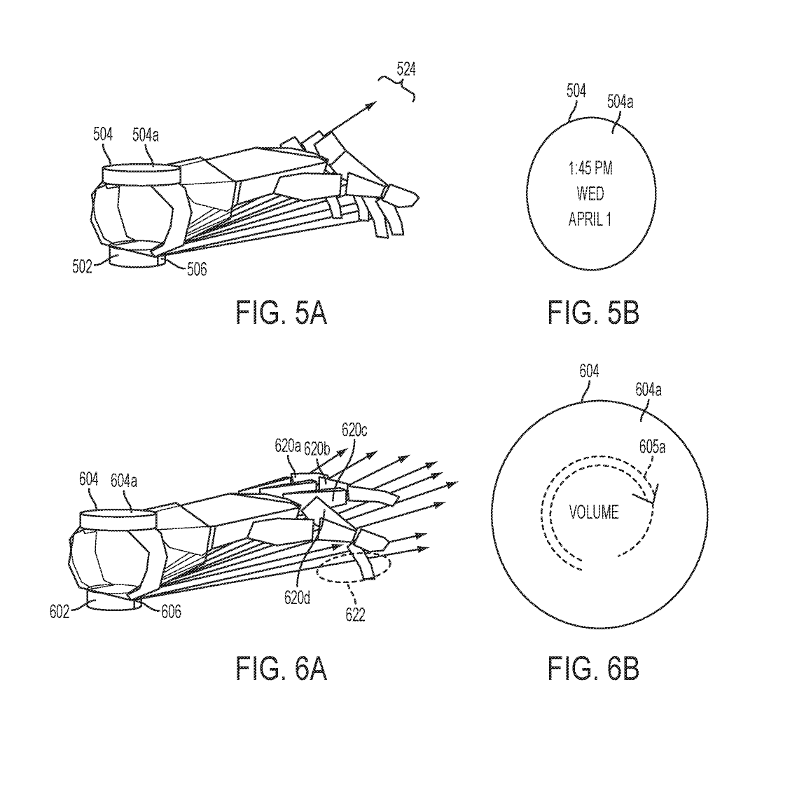

FIG. 5A illustrates a perspective view of an embodiment used with a left hand, with the palm facing down. FIG. 5A shows fingers 520a-520d, which may be similar to fingers 220a-22d of FIG. 2, that are in a lowered position, blocking some of beams 524, which may be similar to beams 224 of FIG. 2. In embodiments, the wrist/finger sensor 506, which may be similar to wrist/finger sensor 106 of FIG. 1, may detect the reflection of blocked beams.

FIG. 5B illustrates the face of a smartwatch 504, which may be similar to mobile device 104 of FIG. 1, having a display face 504a. The smartwatch 504 may be running an application which, upon detecting at least four fingers in a closed position, may send an indication of one or more commands to the smartwatch 504 to display a current time, day and date to appear on the watch face 504a.

FIG. 6A illustrates a perspective view of an embodiment used on a left hand, with the palm facing down. FIG. 6A shows an index finger 620d, which may be similar to finger 220d of FIG. 2, in lowered position and rotating in a circle 622, blocking some of the beams 624, which may be similar to some of the beams 224 of FIG. 2.

FIG. 6B illustrates the face of a smartwatch 604, which may be similar to mobile device 104 of FIG. 1, having a display face 604a. The smartwatch 604 may be running an application displaying a volume control 605a on the smartwatch display face 604a, and the user may be allowed to increase or decrease the volume of the smartwatch 604. A finger 620d, when moved circularly in a clockwise or counter clockwise rotation 622 may send an indication of one or more commands to implement a function to increase or decrease the volume control and volume control display 605a.

In addition to the examples illustrated in FIG. 3A-6B, other detected hand gestures may be used for an application, or across multiple applications and/or devices, to indicate functions to perform on one or more mobile device 104, for example smartwatch 604. These may include, interacting with a user interface 604a in various ways, including, but not limited to: zooming in and zooming out by moving the pinky finger and thumb in opposing and contracting motions; moving a cursor by moving one or more fingers; selecting a highlighted button by double-tapping the middle finger; or panning or switching between pages by moving multiple fingers in a paddling motion.

In embodiments, detected finger locations and movements may be used to enter alphanumeric characters, as well as other symbols, into an application running on the mobile device 104. In embodiments, input using hand gestures may be augmented by other modes of input, for example auditory input or input from a second device that may be controlled by a user with the hand not wearing the smartwatch.

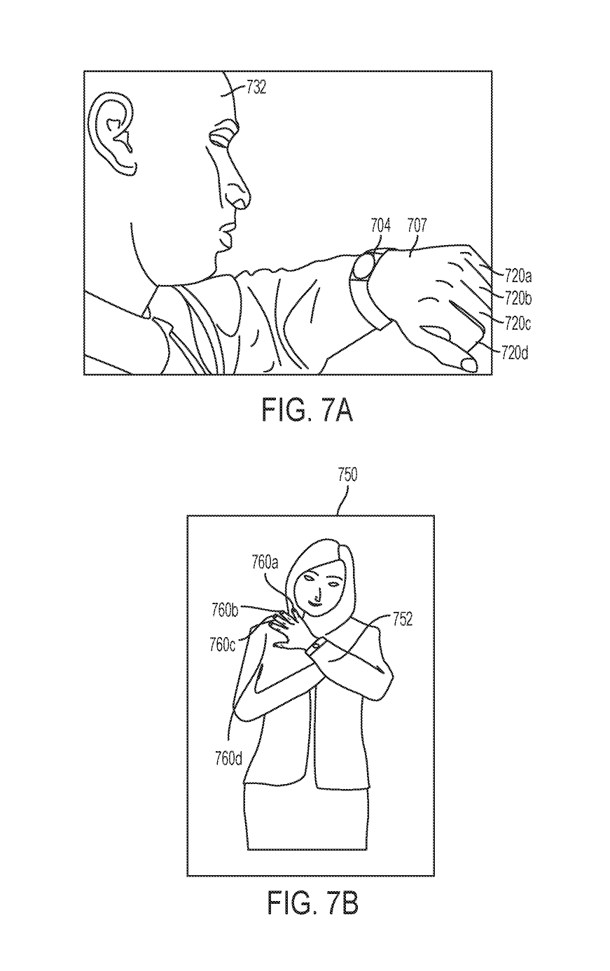

FIG. 7A-7B illustrate example behaviors of individuals viewing a smartwatch device, in accordance with some embodiments.

FIG. 7A shows a user 732 viewing a smartwatch 704, which may be similar to the mobile device 104 of FIG. 1, that is attached to the person's wrist 707. The wrist 707 has been rotated and raised to better allow the user 732 view the smartwatch 704, as the user normally does when wishing to view the smartwatch 704. In addition, the user's fingers 720a-720d are in a cupped position.

In a survey of Internet photos having at least one person looking at a wristwatch, a vast majority of those persons, approximately 94%, look at their watch with their hand in a cupped position or in a position like a fist.

FIG. 7B shows a person 750 viewing a smartwatch 752 with an open hand where fingers 760a-760d are open, or had fingers shown in positions other than the hand position depicted in FIG. 7A. A minority of users, approximately 6%, may look at their smartwatch 752 in this way.

In embodiments, the gesture sensor 102 may use hand position data to determine when the user intended to look at a watch. In embodiments, by analyzing the user's finger positions, angle of arm, and/or arm motion, the gesture sensor 102 may identify likely times when the user wants to look at the watch, and may turn the watch on without a perceived delay by the user. In embodiments, turning on a smartwatch display may also act as a starting point for an interactive session between the user and the smartwatch. In embodiments, the gesture sensor 102 may learn, for example through unsupervised machine learning, when the user may wish to view the smartwatch device.

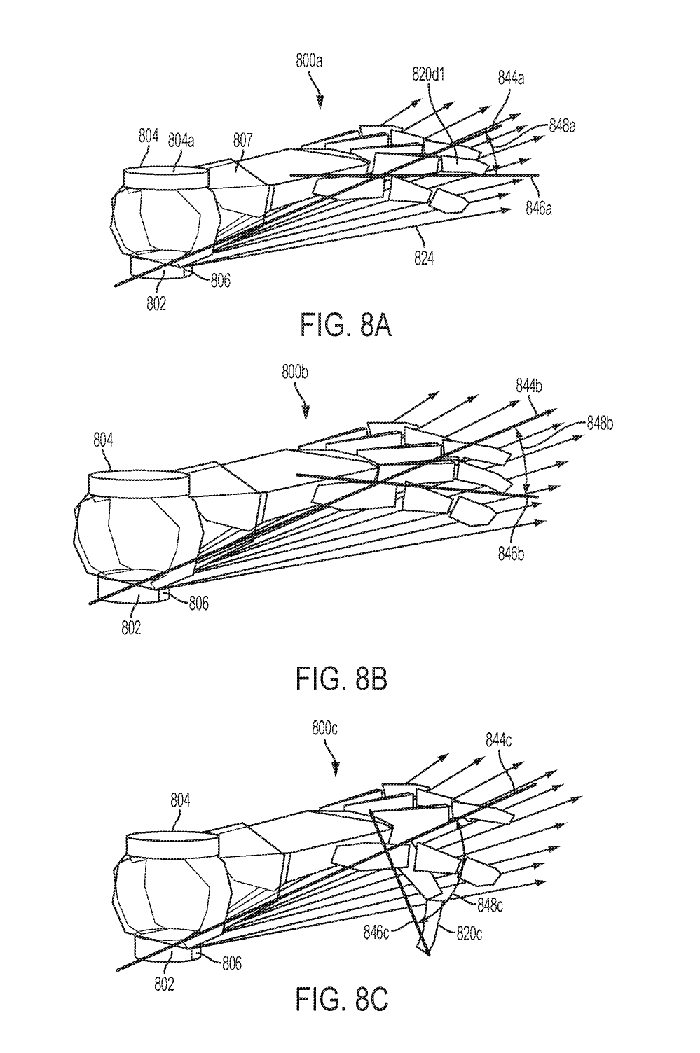

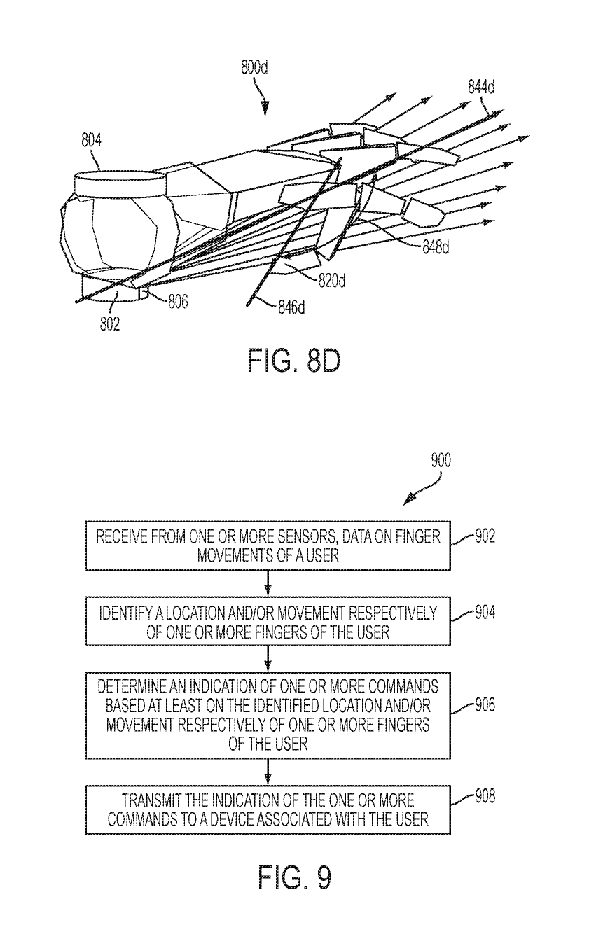

FIGS. 8A-8D illustrate four perspective views of determining the extension and/or contraction range of a pointer finger using an under-wrist mounted gesturing device, in accordance with some embodiments. In embodiments, the gesture sensor 802, which may be similar to gesture sensor 102 of FIG. 1, may determine the initial orientation of the fingers 820a-820e, particularly the index finger 820d. In embodiments, the orientation of the fingers 820a-820e may correspond to coordinates on the mobile device display 804a. In embodiments, ongoing observations of fingers 820a-820e may be used to adjust and/or calibrate the sensing of the location and the movements of the fingers 820a-820e. Such adjusting and/or calibrating, in non-limiting examples, may be performed during a training period and/or may be learned during operation of the gesture sensor 802.

In embodiments, this adjusting and/or calibrating may include determining a range of motion of an index finger 820d. Diagram 800a shows an example left hand that may have a mobile device such as a smartwatch 804 having a display 804a attached to a user's wrist 807. A gesture sensor 802 may be attached to the underside of the user wrist 807, and may include a wrist/finger sensor 806, which may be similar to the wrist/finger sensor 106 of FIG. 1. The gesture sensor 802 may emit a plurality of beams 824, which may be similar to beams 224 of FIG. 2, and may detect when these plurality of beams 824 encounter one or more parts of a finger 820d in order to determine a location and/or movement of the one or more parts of the finger 820d.

Diagram 800a may show a maximum extended range for an index finger 820d, and show an angle difference “a” 848a, between the angle line of the maximally extended index FIG. 846a, and a palm center line 844a.

Diagram 800d may show a maximum contracted range for an index finger 820d2, and show an angle difference “d” between the angle line of the maximally contracted finger 820d2 and a palm center line 844d. In embodiments, the pair (a,d) may represent the total range of motion for the index finger 820d that represents the maximum extended range and the maximum contracted range.

However, this range may not be the same as a comfortable range of motion, which, in embodiments, may be calculated based on observations of the range of motion exhibited by a user. In embodiments, these observations may be made during a configuration phase of system setup or through an initial learning phase with pre-configured default values set by the manufacturer.

Diagram 800c shows an index finger 820d3 with an angle difference “c” 848c of a comfortably contracted index finger 846c, and a palm center line 844c. Diagram 800b shows an index finger 820d2 with an angle difference “b” 848b of a comfortably extended index finger 846b, and palm center line 844b.

In embodiments, the comfortable range of motion may be determined by the median, or by similar mathematical methods, of the values of observed the figure positions. In embodiments, an initial value may be determined based at least on the maximum angles “a” 848a and “d” 848d.

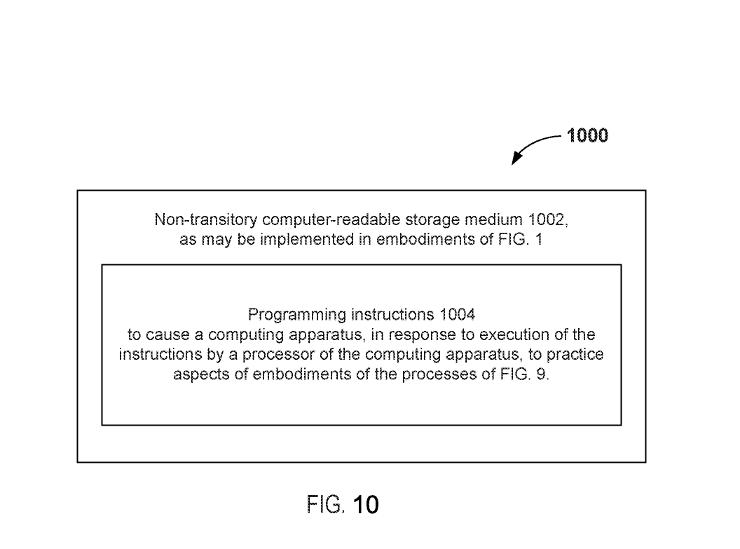

FIG. 9 is a block diagram that illustrates a method for implementing an under-wrist mounted gesturing device, in accordance with some embodiments. In some embodiments, the hand gesture sensor 102 of FIG. 1 may perform one or more processes, such as the process 900.

At block 902, the process may receive, from one or more sensors, data on finger movements of a user. In embodiments, this information may come from a wrist/finger sensor 106 that may be part of a gesture sensor 102, or may be a separate device from the gesture sensor 102 and coupled to the gesture sensor 102.

At block 904, the process may identify a location and/or movement respectively of one or more fingers of the user. In embodiments, this information may be identified by the controller 110 within the gesture sensor 102, and may be further supported by sensor data collection 110a, that may be stored within the gesture sensor 102 and accessible by the controller 110.

At block 906, the process may determine an indication of one or more commands based at least on the identified location and/or movement respectively of one or more fingers of the user.

At block 908, the process may transmit the indication of the one or more commands to a device associated with the user. In embodiments, this device may be a mobile device 104 of FIG. 1, and may be a device such as a smartwatch, 204.

FIG. 10 is a diagram 1000 illustrating computer readable media 1002 having instructions for practicing the above-described techniques, or for programming/causing systems and devices to perform the above-described techniques, in accordance with various embodiments. In some embodiments, such computer readable media 1002 may be included in a memory or storage device, which may be transitory or non-transitory, of the Gesture Sensor apparatus 102 in FIG. 1. In embodiments, instructions 1004 may include assembler instructions supported by a processing device, or may include instructions in a high-level language, such as C, that can be compiled into object code executable by the processing device. In some embodiments, a persistent copy of the computer readable instructions 1004 may be placed into a persistent storage device in the factory or in the field (through, for example, a machine-accessible distribution medium (not shown)). In some embodiments, a persistent copy of the computer readable instructions 1004 may be placed into a persistent storage device through a suitable communication pathway (e.g., from a distribution server).

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

### EXAMPLES

Examples, according to various embodiments, may include the following.

Example 1 may be an under-wrist apparatus for determining hand gestures of a user, comprising: one or more sensors to be attached to the underside of a wrist of a user to collect sensor data on finger movements of the user; and circuitry coupled to the one or more sensors to process the sensor data to: identify a location or movement of a finger of the user; determine, or cause to determine, an indication of one or more commands based at least on the identified location or movement of the finger; and transmit or cause to transmit the indication of the one or more commands to a device associated with the user.

Example 2 may include the subject matter of Example 1, wherein the circuitry is proximally disposed at the underside of the wrist of the user.

Example 3 may include the subject matter of Example 1, wherein to identify the location or the movement of the finger of the user, the circuitry is further to: detect a position of a first part of the finger relative to the one or more sensors and determine the location of the finger based on the detection; or detect, at a first time, a first position of a second part of the finger relative to the one or more sensors, detect, at a second time, a second position of the second part of the finger relative to the one or more sensors, compare the first position of the second part of the finger at the first time with the second position of the second part of the finger at the second time, and identify the movement of the finger based on the comparison.

Example 4 may include the subject matter of Example 3, wherein the one or more sensors comprise one or more infrared sensor, acoustic sensor, laser sensor, depth-sensing cameras, accelerometer, compass, or stereoscopic sensor.

Example 5 may include the subject matter of Example 1, wherein the one or more sensors are further to determine a rate or a degree of rotation of the wrist of the user; and wherein the circuitry is further, upon the rate or the degree of rotation exceeding a threshold value, to transmit or cause to transmit an indication of one or more commands to the device associated with the user.

Example 6 may include the subject matter of Example 5, wherein the rotation of the wrist of the user includes multiple rotations of the wrist of the user, and wherein the rate or the degree of rotation exceeding a threshold value includes respectively a plurality of rates and/or a plurality of degrees of rotation exceeding a plurality of threshold values.

Example 7 may include the subject matter of Example 5, wherein the device is a mobile device attached to a top of the wrist; and wherein, on the rate or the degree of rotation exceeding the threshold value, the circuitry is to transmit or cause to transmit an indication of one or more commands to the device.

Example 8 may include the subject matter of any Examples 6 or 7, wherein the movement of a finger further includes the movement of one or more fingers, and on determination of a movement of the one or more fingers, the circuitry is to transmit or cause to transmit an indication of one or more commands to the device.

Example 9 may include the subject matter of Example 8, wherein the indication of one or more commands includes an indication to: select a menu button on a display of the device, wherein the menu button corresponds to the one of the plurality of fingers; move a cursor on the display of the device based upon the movement of the one or more fingers; display information on the display of the device; alter the presentation of information on the display of the device; transmit an alphanumeric character input to the device; or execute a command on the device based on one or more predefined sequences of movements of the one or more fingers.

Example 10 may include the subject matter of Example 1, wherein the device is a smartwatch; and wherein the circuitry is further to, on the rotation of the wrist of the user above a threshold value or on a movement of one or more fingers that indicate hand cupping, transmit an indication to the smartwatch to activate and display data.

Example 11 may include the subject matter of Example 1, wherein the circuitry is further to: receive an indication that haptic feedback is to be provided to the user; and provide the haptic feedback to the user.

Example 12 may be a method for implementing an under-wrist apparatus for determining hand gestures of a user, comprising: receiving, by the under-wrist apparatus, from one or more sensors, data on finger movements of the user; identifying, by the under-wrist apparatus, a location and/or movement respectively of one or more fingers of the user; determining, by the under-wrist apparatus, an indication of one or more commands based at least on the identified location and/or movement respectively of one or more fingers of the user; and transmitting, by the under-wrist apparatus, the indication of the one or more commands to a device associated with the user.

Example 13 may include the subject matter of Example 12, wherein the under-wrist device is proximally disposed at the underside of the wrist of the user.

Example 14 may include the subject matter of Example 12, wherein the one or more sensors comprise one or more infrared sensor, acoustic sensor, laser sensor, depth-sensing cameras, accelerometer, compass, or stereoscopic sensor.

Example 15 may include the subject matter of Example 12, wherein identifying the location and/or the movement of the one or more fingers of the user further includes: detecting a position of a first part of one of the one or more fingers relative to the one or more sensors and determining the location of the one of the one or more fingers based on the detection; or detecting, at a first time, a first position of a second part of the one or more fingers relative to the one or more sensors, detecting, at a second time, a second position of the second part of the one or more fingers relative to the one or more sensors, comparing the first position of the second part of the one or more fingers at the first time with the second position of the second part of the one or more fingers at the second time, and identifying the movement of the one or more fingers based on the comparison.

Example 16 may include the subject matter of Example 15, further comprising: determining, by the one or more sensors, a rate or a degree of rotation of the wrist of the user; and upon the rate or the degree of rotation exceeding a threshold value, transmitting, by the under-wrist apparatus, an indication of one or more commands to the device associated with the user.

Example 17 may include the subject matter of Example 16, wherein the rotation of the wrist of the user includes multiple rotations of the wrist of the user, and wherein the rate or the degree of rotation exceeding a threshold value includes respectively a plurality of rates and/or a plurality of degrees of rotation exceeding a plurality of threshold values.

Example 18 may include the subject matter of Example 16, wherein the device is a mobile device attached to a top of the wrist; and wherein, on the rate or the degree of rotation exceeding the threshold value, transmitting, by the under-wrist apparatus, an indication of one or more commands to the device.

Example 19 may include the subject matter of any Examples 17 of 18, wherein the movement of a finger further includes the movement of one or more fingers, and on determination of a movement of the one or more fingers, transmitting, by the under-wrist apparatus, an indication of one or more commands to the device.

Example 20 may include the subject matter of Example 19, wherein the indication of one or more commands includes an indication to: select a menu button on a display of the device, wherein the menu button corresponds to the one of the plurality of fingers; move a cursor on the display of the device based upon the movement of the one or more fingers; display information on the display of the device; alter the presentation of information on the display of the device; transmit an alphanumeric character input to the device; or execute a command on the device based on one or more predefined sequences of movements of the one or more fingers.

Example 21 may include the subject matter of Example 12, wherein the device is a smartwatch; and wherein on the rotation of the wrist of the user above a threshold value or on a movement of one or more fingers that indicate hand cupping, transmitting, by the under-wrist apparatus, an indication to the smartwatch to activate and display data.

Example 22 may include the subject matter of Example 12, further comprising: receiving, by the under-wrist apparatus, from a mobile device, an indication that haptic feedback is to be provided to the user; and providing, by the under-wrist apparatus, the haptic feedback.

Example 23 may be one or more computer-readable media comprising instructions that cause a computing device, in response to execution of the instructions by the computing device, to: receive, by the computing device, from one or more sensors, data on finger movements of the user; identify, by the computing device, a location and/or movement respectively of one or more fingers of the user; determine, by the computing device, an indication of one or more commands based at least on the identified location and/or movement respectively of one or more fingers of the user; and transmitting, by the computing device, the indication of the one or more commands to a device associated with the user.

Example 24 may include the subject matter of Example 23, wherein the computing device is proximally disposed at the underside of the wrist of the user.

Example 25 may include the subject matter of Example 23, wherein identify the location and/or the movement of the one or more fingers of the user further includes: detect a position of a first part of one of the one or more fingers relative to the one or more sensors and determine the location of the one of the one or more fingers based on the detection; or detect, at a first time, a first position of a second part of the one or more fingers relative to the one or more sensors, detect, at a second time, a second position of the second part of the one or more fingers relative to the one or more sensors, compare the first position of the second part of the one or more fingers at the first time with the second position of the second part of the one or more fingers at the second time, and identify the movement of the one or more fingers based on the comparison.

Example 26 may include the subject matter of Example 23, wherein the one or more sensors comprise one or more infrared sensor, acoustic sensor, laser sensor, depth-sensing cameras, accelerometer, compass, or stereoscopic sensor.

Example 27 may include the subject matter of Example 23, further comprising: determine, by the one or more sensors, a rate or a degree of rotation of the wrist of the user; and upon the rate or the degree of rotation exceeding a threshold value, transmit, by the computing apparatus, an indication of one or more commands to the device associated with the user.

Example 28 may include the subject matter of Example 27, wherein the rotation of the wrist of the user includes multiple rotations of the wrist of the user, and wherein the rate or the degree of rotation exceeding a threshold value includes respectively a plurality of rates and/or a plurality of degrees of rotation exceeding a plurality of threshold values.

Example 29 may be the one or more computer-readable media of claim 28, wherein the device is a mobile device attached to a top of the wrist; and wherein, on the rate or the degree of rotation exceeding the threshold value, transmit, by the computing apparatus, an indication of one or more commands to the device.

Example 30 may include the subject matter of any Examples 28 or 29, wherein the movement of a finger further includes the movement of one or more fingers, and on determination of a movement of the one or more fingers, transmit, by the under-wrist apparatus, an indication of one or more commands to the device.

Example 31 may include the subject matter of Example 30, wherein the indication of one or more commands includes an indication to: select a menu button on a display of the device, wherein the menu button corresponds to the one of the plurality of fingers; move a cursor on the display of the device based upon the movement of the one or more fingers; display information on the display of the device; alter the presentation of information on the display of the device; transmit an alphanumeric character input to the device; or execute a command on the device based on one or more predefined sequences of movements of the one or more fingers.

Example 32 may include the subject matter of Example 29, wherein the device is a smartwatch; and wherein on the rotation of the wrist of the user above a threshold value or on a movement of one or more fingers that indicate hand cupping, transmit, by the under-wrist apparatus, an indication to the smartwatch to activate and display data.

Example 33 may include the subject matter of Example 23, further comprising: receive, by the computing apparatus, from a mobile device, an indication that haptic feedback is to be provided to the user; and provide, by the under-wrist apparatus, the haptic feedback.

Example 34 may be an under-wrist apparatus for determining hand gestures of a user, comprising: means for receiving, from one or more sensors, data on finger movements of the user; means for identifying a location and/or movement respectively of one or more fingers of the user; means for determining an indication of one or more commands based at least on the identified location and/or movement respectively of one or more fingers of the user; and means for transmitting the indication of the one or more commands to a device associated with the user.

Example 35 may include the subject matter of Example 34, wherein the under-wrist device is proximally disposed at the underside of the wrist of the user.

Example 36 may include the subject matter of Example 34, wherein identifying the location and/or the movement of the one or more fingers of the user further includes: means for detecting a position of a first part of one of the one or more fingers relative to the one or more sensors and means for determining the location of the one of the one or more fingers based on the detection; or means for detecting, at a first time, a first position of a second part of the one or more fingers relative to the one or more sensors, means for detecting, at a second time, a second position of the second part of the one or more fingers relative to the one or more sensors, means for comparing the first position of the second part of the one or more fingers at the first time with the second position of the second part of the one or more fingers at the second time, and means for identifying the movement of the one or more fingers based on the comparison.

Example 37 may include the subject matter of Example 34, wherein the one or more sensors comprise one or more infrared sensor, acoustic sensor, laser sensor, depth-sensing cameras, accelerometer, compass, or stereoscopic sensor.

Example 38 may include the subject matter of Example 34, further comprising: means for determining a rate or a degree of rotation of the wrist of the user; and upon the rate or the degree of rotation exceeding a threshold value, means for transmitting an indication of one or more commands to the device associated with the user.

Example 39 may include the subject matter of Example 38, wherein the rotation of the wrist of the user includes multiple rotations of the wrist of the user, and wherein the rate or the degree of rotation exceeding a threshold value includes respectively a plurality of rates and/or a plurality of degrees of rotation exceeding a plurality of threshold values.

Example 40 may include the subject matter of Example 38, wherein the device is a mobile device attached to a top of the wrist; and wherein, on the rate or the degree of rotation exceeding the threshold value, means for transmitting, by the under-wrist apparatus, an indication of one or more commands to the device.

Example 41 may include the subject matter of Example 39 or 40, wherein the movement of a finger further includes the movement of one or more fingers, and on determination of a movement of the one or more fingers, means for transmitting, by the under-wrist apparatus, an indication of one or more commands to the device.

Example 42 may include the subject matter of Example 41, wherein the indication of one or more commands includes an indication to: select a menu button on a display of the device, wherein the menu button corresponds to the one of the plurality of fingers; move a cursor on the display of the device based upon the movement of the one or more fingers; display information on the display of the device; alter the presentation of information on the display of the device; transmit an alphanumeric character input to the device; or execute a command on the device based on one or more predefined sequences of movements of the one or more fingers.

Example 43 may include the subject matter of Example 38, wherein the device is a smartwatch; and wherein on the rotation of the wrist of the user above a threshold value or on a movement of one or more fingers that indicate hand cupping, transmitting, by the under-wrist apparatus, an indication to the smartwatch to activate and display data.

Example 44 may include the subject matter of Example 34, further comprising: receiving, by the under-wrist apparatus, from a mobile device, an indication that haptic feedback is to be provided to the user; and providing, by the under-wrist apparatus, the haptic feedback.

What is claimed is:

1. An under-wrist apparatus for determining hand gestures of a user, comprising:
one or more sensors to be attached to the underside of a wrist of a user to collect sensor data on finger movements of the user; and
circuitry coupled to the one or more sensors to process the sensor data to:
identify a location or movement of a finger of the user;
determine, or cause to determine, an indication of one or more commands based at least on the identified location or movement of the finger; and
transmit or cause to transmit the indication of the one or more commands to a device associated with the user.

2. The apparatus of claim 1, wherein the circuitry is proximally disposed at the underside of the wrist of the user.

3. The apparatus of claim 1, wherein to identify the location or the movement of the finger of the user, the circuitry is further to:
detect a position of a first part of the finger relative to the one or more sensors and determine the location of the finger based on the detection; or
detect, at a first time, a first position of a second part of the finger relative to the one or more sensors, detect, at a second time, a second position of the second part of the finger relative to the one or more sensors, compare the first position of the second part of the finger at the first time with the second position of the second part of the finger at the second time, and identify the movement of the finger based on the comparison.

4. The apparatus of claim 3, wherein the one or more sensors comprise one or more infrared sensor, acoustic sensor, laser sensor, depth-sensing cameras, accelerometer, compass, or stereoscopic sensor.

5. The apparatus of claim 1, wherein the one or more sensors are further to determine a rate or a degree of rotation of the wrist of the user; and wherein the circuitry is further, upon the rate or the degree of rotation exceeding a threshold value, to transmit or cause to transmit an indication of one or more commands to the device associated with the user.

6. The apparatus of claim 5, wherein the rotation of the wrist of the user includes multiple rotations of the wrist of the user, and wherein the rate or the degree of rotation exceeding a threshold value includes respectively a plurality of rates and/or a plurality of degrees of rotation exceeding a plurality of threshold values.

7. The apparatus of claim 5, wherein the device is a mobile device attached to a top of the wrist; and
wherein, on the rate or the degree of rotation exceeding the threshold value, the circuitry is to transmit or cause to transmit an indication of one or more commands to the device.

8. The apparatus of any of claim 6 or 7, wherein the movement of a finger further includes the movement of one or more fingers, and on determination of a movement of the one or more fingers, the circuitry is to transmit or cause to transmit an indication of one or more commands to the device.

9. The apparatus of claim 8, wherein the indication of one or more commands includes an indication to:
select a menu button on a display of the device, wherein the menu button corresponds to the one of the plurality of fingers;
move a cursor on the display of the device based upon the movement of the one or more fingers;
display information on the display of the device;
alter the presentation of information on the display of the device;
transmit an alphanumeric character input to the device; or
execute a command on the device based on one or more predefined sequences of movements of the one or more fingers.

10. The apparatus of claim 1, wherein the device is a smartwatch; and
wherein the circuitry is further to, on the rotation of the wrist of the user above a threshold value or on a movement of one or more fingers that indicate hand cupping, transmit an indication to the smartwatch to activate and display data.

11. The apparatus of claim 1, wherein the circuitry is further to:
receive an indication that haptic feedback is to be provided to the user; and
provide the haptic feedback to the user.

12. A method for implementing an under-wrist apparatus for determining hand gestures of a user, comprising:
receiving, by the under-wrist apparatus, from one or more sensors, data on finger movements of the user;
identifying, by the under-wrist apparatus, a location and/or movement respectively of one or more fingers of the user;
determining, by the under-wrist apparatus, an indication of one or more commands based at least on the identified location and/or movement respectively of one or more fingers of the user; and
transmitting, by the under-wrist apparatus, the indication of the one or more commands to a device associated with the user.

13. The method of claim 12, wherein the one or more sensors comprise one or more infrared sensor, acoustic sensor, laser sensor, depth-sensing cameras, accelerometer, compass, or stereoscopic sensor.

14. The method of claim 12, wherein identifying the location and/or the movement of the one or more fingers of the user further includes:
detecting a position of a first part of one of the one or more fingers relative to the one or more sensors and determining the location of the one of the one or more fingers based on the detection; or
detecting, at a first time, a first position of a second part of the one or more fingers relative to the one or more sensors, detecting, at a second time, a second position of the second part of the one or more fingers relative to the one or more sensors, comparing the first position of the second part of the one or more fingers at the first time with the second position of the second part of the one or more fingers at the second time, and identifying the movement of the one or more fingers based on the comparison.

15. One or more computer-readable media comprising instructions that cause a computing device, in response to execution of the instructions by the computing device, to:
receive, by the computing device, from one or more sensors, data on finger movements of the user;
identify, by the computing device, a location and/or movement respectively of one or more fingers of the user;
determine, by the computing device, an indication of one or more commands based at least on the identified location and/or movement respectively of one or more fingers of the user; and
transmitting, by the computing device, the indication of the one or more commands to a device associated with the user.

16. The one or more computer-readable media of claim 15, further comprising:
determine, by the one or more sensors, a rate or a degree of rotation of the wrist of the user; and
upon the rate or the degree of rotation exceeding a threshold value, transmit, by the computing apparatus, an indication of one or more commands to the device associated with the user.

17. The one or more computer-readable media of claim 16, wherein the rotation of the wrist of the user includes multiple rotations of the wrist of the user, and wherein the rate or the degree of rotation exceeding a threshold value includes respectively a plurality of rates and/or a plurality of degrees of rotation exceeding a plurality of threshold values.

18. The one or more computer-readable media of claim 17, wherein the device is a mobile device attached to a top of the wrist; and
wherein, on the rate or the degree of rotation exceeding the threshold value, transmit, by the computing apparatus, an indication of one or more commands to the device.

19. The one or more computer-readable media of any of claim 17 or 18, wherein the movement of a finger further includes the movement of one or more fingers, and on determination of a movement of the one or more fingers, transmit, by the under-wrist apparatus, an indication of one or more commands to the device.

20. The one or more computer-readable media of claim 15, further comprising:
receive, by the computing apparatus, from a mobile device, an indication that haptic feedback is to be provided to the user; and
provide, by the under-wrist apparatus, the haptic feedback.
